(19) United States
(12) Patent Application Publication
(10) Pub. No.: US 2015/0108844 A1
(43) Pub. Date: Apr. 23, 2015

(54) HYBRID ENERGY STORAGE SYSTEM

(71) Applicant: General Electric Company, Schenectady, NY (US)

(72) Inventors: Rui Zhou, Niskayuna, NY (US); Luis Jose Garces, Niskayuna, NY (US); Rixin Lai, Clifton Park, NY (US)

(73) Assignee: General Electric Company, Schenectady, NY (US)

(21) Appl. No.: 14/058,641

(22) Filed: Oct. 21, 2013

(51) Int. Cl. H02J 9/06; H02J 1/00

(52) U.S. Cl. CPC H02J 9/062; H02J 1/00
USPC 307/80; 363/131

(57) ABSTRACT

A power converter is provided. The power converter includes a converter leg comprising a plurality of active power link modules coupled to each other. Each of the plurality of active power link module includes exactly two semiconductor switches comprising antiparallel diodes and wherein the antiparallel diodes are coupled in parallel to the respective switches, a filter inductor coupled to a node between the two semiconductor switches, a filter capacitor coupled in parallel across the at least two semiconductor switches and a power storage element directly coupled in parallel to the filter capacitor.

### BACKGROUND

Embodiments of the invention relate generally to an energy storage system and, more particularly, to a hybrid energy storage and management system.

Energy storage systems are used for various applications and are fabricated based on the application for which the energy storage system may be used. One such application may include using an energy storage system to provide auxiliary power to another system. The energy storage system includes an energy storage element that stores energy that may be used for providing the auxiliary power. Different types of energy storage systems may be fabricated using different types of energy storage elements.

Hybrid energy storage systems are energy storage systems that include more than one type of energy storage element for storing energy. One such hybrid energy storage system includes a battery and an ultra-capacitor. The hybrid energy storage system includes one DC-DC converter coupled to the battery and another DC-DC converter coupled to the ultra-capacitor. The hybrid energy storage system also includes an inverter that receives an output of each of the DC-DC converters and converts DC power to AC power that is used by the load. The use of two DC-DC converters and the inverter leads to increased complexity, cost, and size.

Hence, there is a need for an improved system to address the aforementioned issues.

### BRIEF DESCRIPTION

Briefly, in accordance with one embodiment, a power converter is provided. The power converter includes a converter leg comprising a plurality of active power link modules coupled to each other. Each of the plurality of active power link module comprises exactly two semiconductor switches comprising antiparallel diodes and wherein the antiparallel diodes are coupled in parallel to the respective switches, a filter inductor coupled to a node between the at least two semiconductor switches, a filter capacitor coupled in parallel across the at least two semiconductor switches, and a power storage element directly coupled in parallel to the filter capacitor.

In another embodiment, a system comprising a power converter is provided. The power converter includes a converter leg comprising a plurality of active power link modules coupled to each other. Each of the plurality of active power link modules comprises a power storage element. An energy storage element is coupled to the power converter via a DC link, and a controller is provided for using at least one of the power storage element and the energy storage element for controlling output power of the power converter.

In yet another embodiment, a hybrid storage system is provided. The hybrid storage system includes a housing comprising at least two partitions, a plurality of energy storage elements stacked in a column in a first partition, a plurality of active power link modules coupled to each other and stacked in columns and rows in a second partition, an energy management system coupled to the plurality of energy storage elements and disposed in the first partition, and controller coupled to the energy management system and to the plurality of active power link modules and disposed in the second partition.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a hybrid storage system in accordance with an embodiment of the invention.

FIG. 2 is a schematic representation of an active power link module in accordance with an embodiment of the invention.

FIG. 3 is a block diagram representation of a hybrid storage system including AC loads in accordance with an embodiment of the invention.

FIG. 4 is a block diagram representation of an alternative embodiment of a hybrid storage system including DC loads in accordance with an embodiment of the system.

FIG. 5 is a schematic representation of a two hundred kilowatt hybrid energy storage system in accordance with an embodiment of the invention.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit,” “circuitry,” “controller,” and “processor” may include either a single component or a plurality of components, which are either active and/or passive and are connected or otherwise coupled together to provide the described function.

Embodiments of the present invention include a system comprising a power converter. The power converter includes a converter leg. The converter leg comprises a plurality of active power link modules coupled to each other. Each of the plurality of active power link comprises exactly two semiconductor switches comprising antiparallel diodes and wherein the antiparallel diodes are coupled in parallel to the respective switches, a filter inductor coupled to a node between the at least two semiconductor switches, a filter capacitor coupled in parallel across the at least two semiconductor switches, and a power storage element directly coupled in parallel to the filter capacitor. The system also includes an energy storage element coupled to the power converter via a DC link, and a controller for using at least one of the power storage element and the energy storage element for controlling output power of the power converter.

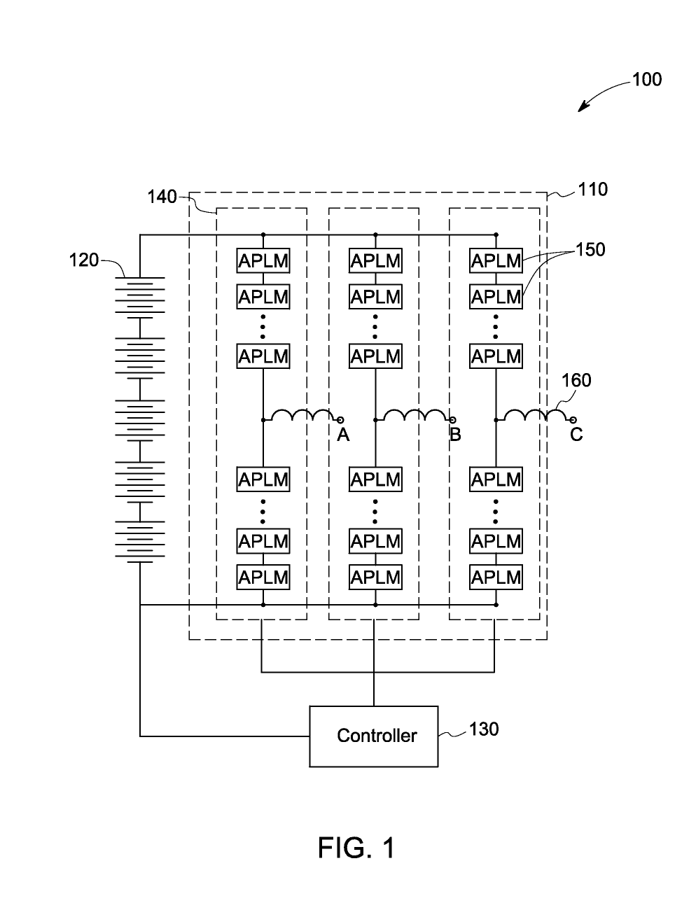

FIG. 1 is a schematic representation of a hybrid storage system 100 in accordance with an embodiment of the invention. The hybrid storage system includes a power converter 110, an energy storage element 120, and a controller 130 coupled to the power converter 110 and the energy storage element 120. The power converter 110 includes a converter leg 140. In one embodiment, the converter leg 140 comprises three converter legs, respectively, for three phases. The converter leg 140 includes a plurality of active power link modules 150 that are coupled to each other in series. In one embodiment, each of the plurality of active power link modules 150 converts power independently with different voltage levels to provide a near sinusoidal waveform of an output voltage. Each of the plurality of active power link modules 150 is coupled to the controller 130 that controls power conversion operations of the plurality of active power link modules 150. The power converter 100 is also coupled in parallel to the energy storage element 120. In a more specific embodiment, the energy storage element 120 may include a battery. In one embodiment, a number of energy storage elements 120 that may be coupled in series in the hybrid storage system 100 depend on a power rating of the hybrid storage system 100. The controller 130 also controls a flow of current from the energy storage element 120 to an output node 160. In some situations, the controller 130 further controls a flow of current from the output node 160 to the energy storage element 120. In such situations, the energy storage element 120 stores an excessive current present at the output node 160. In one embodiment, each of the plurality of active power link modules 150 may include a local controller. In some embodiments, two or more active power link modules 150 may share a local controller. In another embodiment, each of the plurality of active power link modules 150 may be controlled by a central controller as shown in FIG. 1. In some embodiments, the local controller and/or the central controller may be situated in a common housing with the power converter 110 or at a location outside the power converter 110.

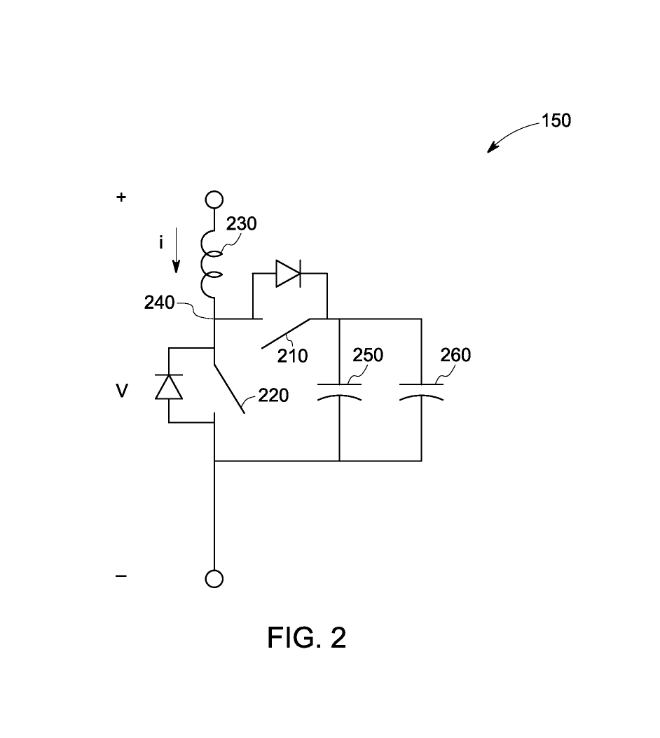

FIG. 2 is a schematic representation of one active power link module 150 of the power converter 100 (FIG. 1) in accordance with an embodiment of the invention. The active power link module 150 includes a first semiconductor switch 210 and a second semiconductor switch 220 coupled in parallel to each other. Each of the semiconductor switches 210, 220 includes a diode coupled in an antiparallel manner with respect to the first semiconductor switch 210 and the second semiconductor switch 220. In one embodiment, the first and the second semiconductor switches may include an insulated gate bipolar transistor, a metal oxide semiconductor field effect transistor, a field effect transistor, an injection enhanced gate transistor, an integrated gate commutated thyristor, or combinations thereof. In another embodiment, the first and the second semiconductor switches may include a gallium arsenide based switch, a gallium nitride based switch, a silicon carbide based switch, or combinations thereof. The active power link module 150 also includes a filter inductor 230 coupled to a node 240 between the first semiconductor switch 210 and the second semiconductor switch 220. The filter inductor 230 is used to reduce effects of a fault condition arising within the power converter or outside the power converter. The active power link module 150 also includes a filter capacitor 250 coupled in parallel to the two semiconductor switches 210, 220. The active power link module 150 further includes a power storage element 260 that stores auxiliary power to be used when required. The power storage element 260 is directly coupled in parallel with the filter capacitor 250 such that there is no active electrical component or passive electrical component coupled between the power storage element 260 and the filter capacitor 250. In one embodiment, the power storage element 260 includes an ultra-capacitor. The active power link module 150 is coupled to the controller 130 (FIG. 1), which controls the switching operations of the first semiconductor switch 210 and the second semiconductor switch 220. In one embodiment, the active power link module 150 enables bi-directional flow of power through the power converter 110 of FIG. 1.

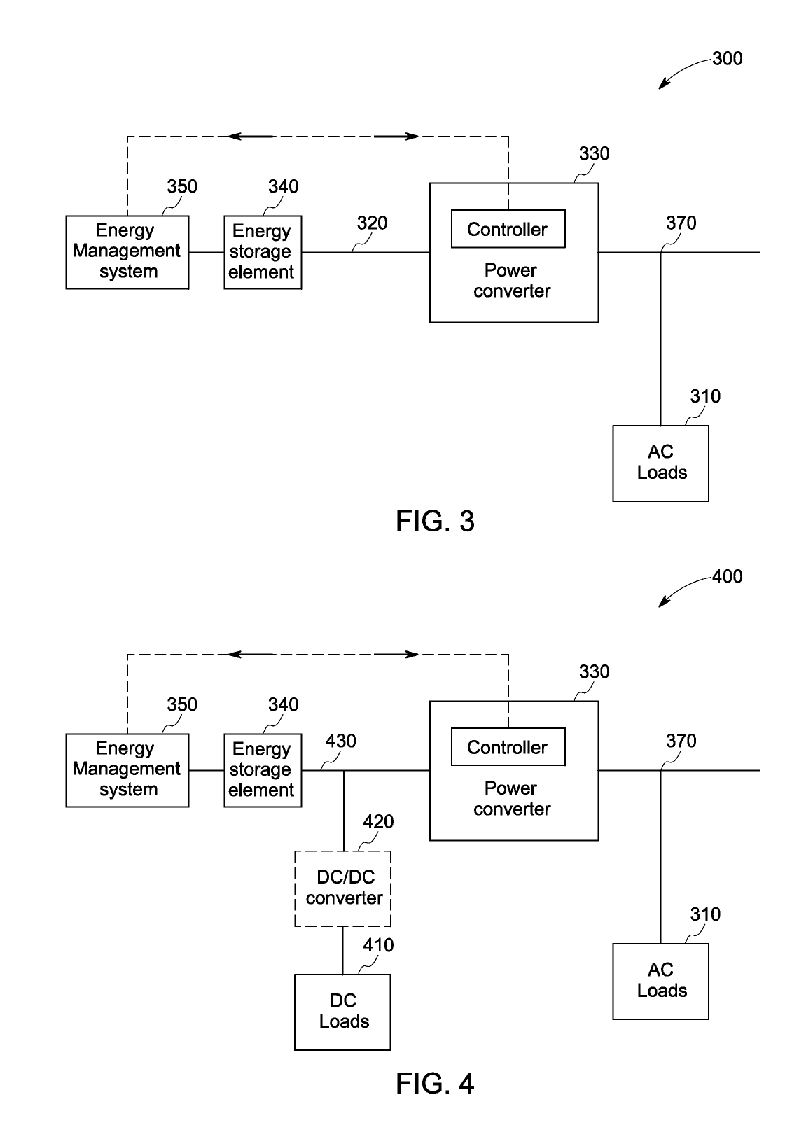

During operation, the controller 130 controls the switching of the first semiconductor switch 210 and the second semiconductor switch 220 between an ON state and an OFF state. The controller 130 determines if an auxiliary power is required by a load (FIG. 3). In one embodiment, the controller 130 may determine the auxiliary power requirement based on a status obtained from the load. Subsequently, the controller 130 switches the first semiconductor switch 210 to an ON state from an OFF state and enables the flow of current from the power storage element 260 of FIG. 2 or the power storage element 120 of FIG. 1 to the load. In situations, where an excessive power is available at the load, the current may flow from the load to the power storage element 260 of FIG. 2 or to the energy storage element 120 of FIG. 1 via the first semiconductor switch 210.

In some situations, if one active power link module 150 fails to operate due to a fault, the controller 130 switches the second semiconductor switch 220 of a failed active power link module (not shown) from the OFF state to the ON state and leaves the first semiconductor switch 210 of the failed active power link module in the OFF state. Such switching configuration of the first semiconductor switch 210 and the second semiconductor switch 220 in the failed active power link module bypasses the failed active power link module and the current flows through a subsequent active power link module.

FIG. 3 is a block diagram representation of the hybrid storage system 300 including AC loads 310 in accordance with an embodiment of the invention. The hybrid storage system 300 includes a power converter 330 coupled to the energy storage element 340 via a DC link 320. The energy storage element 340 is coupled to an energy management system 350 that manages a flow of energy from the energy storage element 340 to the power converter 330. For purposes of illustration, the controller 360 is illustrated as being situated within the power converter 330, and the energy management system 350 is illustrated as being situated outside of the controller 360. However, the controller 360 and the energy management system 350 may be situated in any convenient location or locations. The energy management system 350 manages the flow of energy at least on part based on control commands received from the controller 360. The energy management system 350 also monitors operating information related to the energy storage element 340 and transmits the operating information to the controller 360. In one embodiment, the operating information may include a charging status of the energy storage element 340.

The energy storage element 340 transmits DC current to the power converter 330, and the power converter 330 converts the DC current to AC current that is transmitted to the AC load 310. In one embodiment, the power converter 330 may include a multi-level inverter. The power converter 330 includes a plurality of active power link modules 150 of the type illustrated in FIG. 2. The controller 360 controls the plurality of active power link modules and thus also controls the power storage elements within the active power link modules.

The controller 360 computes the required power output at an output node 370 and selects the power storage elements, the energy storage element 340, or a combination of both to provide the required power output. The controller 360 may also independently control power that is drawn from the energy storage element 340 and the power storage elements in the active power link modules by independently controlling current at the output node 370 and current at the DC link 320. For example, in situations where repetitive charging and discharging of the AC load 310 in short durations is required, the controller 360 uses the power storage elements of the active power link modules 150 (FIG. 2) to provide AC power. In one embodiment, the short durations may include time intervals of several milliseconds to several seconds. In another example, the power storage elements 150 of FIG. 2 may be used in combination with the energy storage element 340 to reduce peak heating loads induced by the operation of the power storage elements in the hybrid storage system 300 and elongate a lifetime of the energy storage element 340.

FIG. 4 is a block diagram representation of an alternative embodiment of a hybrid storage system 400 including DC loads 410 in accordance with an embodiment of the system. Some embodiments of the hybrid storage system 400 may include a DC-DC converter 420 coupled to a DC link 430 that may be used to couple the DC loads 410 to the hybrid energy storage system 400. The DC loads 410 may be coupled simultaneously with the AC loads (FIG. 3) in the hybrid energy storage system 400. The energy management system 350 may coordinate with the controller 360 and the DC/DC converter 420 to manage power flow to the AC loads and the DC loads from the energy storage element 340. For example, a voltage of the DC link 430 may be controlled by the energy management system 350 based on a predefined voltage set point in the DC link. The DC loads 410 are coupled to the DC link 430 and draw power from the DC link 430. Therefore, the controller 360 compares the predefined voltage set point with the voltage of the energy storage element 340. If the predefined voltage set point of the DC link 430 is less than the voltage of the energy storage element 340, the controller 360 enables current to flow from the energy storage element 340 to the DC link 430. If the voltage of the energy storage element 340 is higher than the predefined voltage set point of the DC link 430, the controller 360 controls the current to flow from the DC link 430 to the energy storage element 340 to meet the predefined voltage set point of the DC link 430.

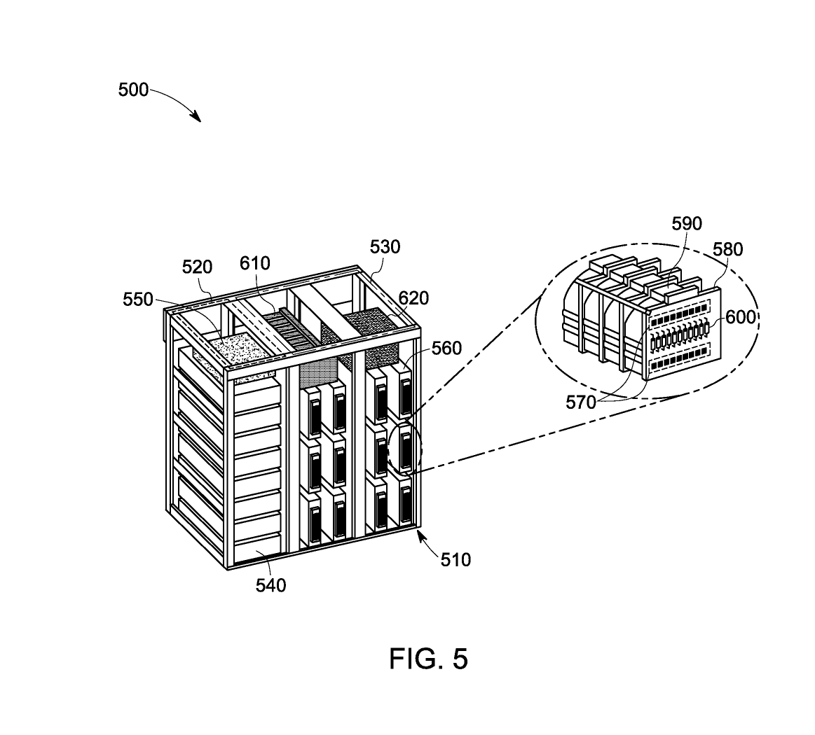

FIG. 5 is a schematic representation of an exemplary two hundred kilowatt hybrid energy storage system 500 in accordance with an embodiment of the invention. For purposes of illustration, but not limitation, various dimensions and numbers of energy storage, power storage, and control elements are described. The hybrid energy storage system 500 includes a housing 510 comprising a first partition 520 and a second partition 530. In one embodiment, the dimensions of the housing 510 may include a width of sixty inches, depth of forty eight inches and a height of seventy two inches. The first partition 520 includes a plurality of energy storage elements 540 stacked in a column In one embodiment, the plurality of energy storage elements 540 includes eight battery modules. The first partition 520 also includes an energy management system 550 coupled to the plurality of energy storage elements 540. In one embodiment, the energy management system 550 is disposed above the plurality of energy storage elements 540. The second partition 530 includes a plurality of active power link modules 560 coupled to each other and stacked in columns and rows. Each of the plurality of active power link modules 560 include exactly two switches 570 coupled in parallel to each other. The two switches 570 are mounted on one or more converter boards 580. In one embodiment, each of switches 570 is made up of a plurality of semiconductor devices to increase the rated current and increase redundancy. In the embodiment of FIG. 5, each of the converter boards 580 is mounted on one power storage element 590 directly coupled to a filter capacitor 600. The plurality of active power link modules 560 form three converter legs (not shown) and each of the converter leg comprises eighteen active power link modules 560. The eighteen active power link modules 560 output eighteen possible voltage levels at an output node (FIG. 3) that results in a near sinusoidal waveform of AC voltage. The hybrid energy storage system 500 also includes an electro-magnetic interference filter inductor (not shown) that filters an electro-magnetic interference from the AC voltage received at the output node and provides a filtered output voltage to an AC load. The eighteen voltage levels of the AC voltage reduce the electro-magnetic interference up to fifty percent which leads to a smaller size of the electro-magnetic interference filter inductor. The hybrid energy storage system 500 further includes seven controllers 610 which control the fifty four active power link modules in the three converter legs and also communicate with the energy management system 550 in the first partition 520. The second partition 530 also includes a circuit breaker 620 that is coupled to the plurality of active power link modules 560 and is disposed in any of the partitions 520, 530.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power converter comprising:
a converter leg comprising a plurality of active power link modules coupled to each other wherein each of the active power link module comprises:
exactly two semiconductor switches comprising antiparallel diodes and wherein the antiparallel diodes are coupled in parallel to respective switches;
a filter inductor coupled to a node between the two semiconductor switches;
a filter capacitor coupled in parallel across the two semiconductor switches; and
a power storage element directly coupled in parallel to the filter capacitor.

2. The power inductor of claim 1, wherein the power converter comprises a single stage power converter.

3. The power converter of claim 1, wherein the power converter enables bi-directional flow of power.

4. The power converter of claim 1, wherein the power storage element comprises an ultra-capacitor.

5. The power converter of claim 1, further comprising a controller for controlling the semiconductor switches.

6. The power converter of claim 1, wherein the two semiconductor switches comprise insulated gate bipolar transistors, metal oxide semiconductor field effect transistors, injection enhanced gate transistors, integrated gate commutated thyristors, or combinations thereof.

7. The power converter of claim 1, wherein the two semiconductor switches comprise gallium arsenide based switches, gallium nitride based switches, a silicon carbide based switches, or combinations thereof.

8. A system comprising:
a power converter comprising a converter leg, wherein the converter leg comprises a plurality of active power link modules coupled to each other, and wherein each of the plurality of active power link comprises exactly two semiconductor switches comprising antiparallel diodes, a filter inductor coupled to a node between the at least two semiconductor switches, a filter capacitor coupled in parallel across the two semiconductor switches, and a power storage element directly coupled in parallel to the filter capacitor;
an energy storage element coupled to the power converter via a DC link; and
a controller for using at least one of the power storage element and the energy storage element for controlling output power of the power converter.

9. The system of claim 8, wherein the power storage element comprises an ultra-capacitor.

10. The system of claim 8, wherein the energy storage element comprises a battery.

11. The system of claim 8, wherein the power converter comprises a single stage power converter.

12. The system of claim 8, wherein the power converter enables bi-directional flow of power.

13. The system of claim 8, further comprising a DC-DC converter coupled to the DC link.

14. The system of claim 13, further comprising a DC load coupled to the DC-DC converter.

15. The system of claim 8, further comprising an AC load coupled to the power converter.

16. The system of claim 8, wherein the converter is programmed to independently control current of the power storage elements and the energy storage element.

17. The system of claim 8, wherein the controller is configured to bypass at least one faulty active power link module.

18. A hybrid storage system comprising:
a housing comprising at least two partitions;
a plurality of energy storage elements stacked in a column in a first partition;
a plurality of active power link modules coupled to each other and stacked in columns and rows in a second partition;
an energy management system coupled to the plurality of energy storage elements and disposed in the first partition; and
a controller coupled to the energy management system and to the plurality of active power link modules and disposed in the second partition.

19. The hybrid storage system of claim 18, wherein each of the plurality of active power link module comprises exactly two semiconductor switches comprising antiparallel diodes, a filter inductor coupled to a node between the at least two semiconductor switches, a filter capacitor coupled in parallel across the two semiconductor switches, and a power storage element directly coupled in parallel to the filter capacitor.

20. The hybrid storage system of claim 18, further comprising a circuit breaker coupled to the plurality of active power link modules and disposed in any of the at least two partitions.
